(19) United States
(12) Patent Application Publication
(10) Pub. No.: US 2013/0049478 A1
(43) Pub. Date: Feb. 28, 2013

(54) POWER SYSTEM, METHOD OF OPERATION THEREOF, AND CONTROLLER FOR OPERATING

(71) Applicant: General Electric Company, Schenectady, NY (US)

(72) Inventors: Robert Gregory Wagoner, Roanoke, VA (US); David Smith, Daleville, VA (US)

(73) Assignee: GENERAL ELECTRIC COMPANY, Schenectady, NY (US)

(21) Appl. No.: 13/649,359

(22) Filed: Oct. 11, 2012

Related U.S. Application Data
(63) Continuation-in-part of application No. 13/218,271, filed on Aug. 25, 2011.

(51) Int. Cl. H02M 7/537; H02J 1/00

(52) U.S. Cl. 307/82; 307/43

(57) ABSTRACT

A power system includes a converter configured to be electrically coupled to a power source, the power source including an energy storage device. An inverter coupled to the converter can transfer power between the converter and an electrical distribution network. A control system coupled to the converter and to the inverter can gradually adjust a voltage across at least one of the converter or the inverter during at least one of a shutdown sequence or a startup sequence of the power converter system.

### BACKGROUND OF THE INVENTION

The disclosure relates generally to power systems including power generation and/or storage devices electrically coupled to an electrical distribution network.

In some known power systems, particularly power generation systems employing so-called renewable resources, a power generation unit and/or an energy storage device can provide electrical energy and transmit the energy to an electrical distribution network or grid, a load, and/or another destination. For example, a solar power system may include a plurality of photovoltaic panels (also known as solar panels) logically or physically grouped in one or more arrays of solar panels that convert solar energy into electrical energy. In addition, such a power system may employ one or more wind turbines, hydroelectric power generation arrangements, and/or other power generation devices, energy storage devices, and/or arrangements.

Such power generation and/or storage systems typically produce and/or provide direct current (DC) electrical power, but typical destinations require alternating current (AC). A power converter is therefore typically interposed between the power generation devices and the destination of the electrical energy to convert DC electrical energy produced to AC electrical energy suitable for receipt by the destination(s). However, if the power is disabled (shut down) or enabled (started up) too quickly, an undesired voltage amplitude may be generated in the power converter, which may lead to damage and/or a reduction in operational lifetime of the power converter.

### BRIEF DESCRIPTION OF THE INVENTION

Embodiments of the invention disclosed herein may take the form of a power system having a power source that includes at least one energy storage device. A control system can be coupled to a converter and an inverter, the converter being coupled to the power source and to a bus, the inverter being coupled to the bus, so that the control system can gradually adjust voltage across the bus during at least one of a shutdown sequence or a startup sequence of the power system.

Embodiments of the invention may also take the form of a method in which at least one a power system or an electrical distribution network for at least one of a shutdown condition or a startup condition. The monitoring of the power system can include monitoring at least one of a power source having at least one energy storage device, a converter coupled to the power source, or an inverter coupled to the converter. If a shutdown condition occurs in at least one of the power source or the electrical distribution network, a response can include gradually reducing a converter duty cycle of at least one converter switch of the converter at a first determined rate and gradually reducing an inverter duty cycle of at least one inverter switch of the inverter at a second determined rate. If a startup condition occurs, a response can include gradually increasing the inverter duty cycle at a third determined rate and gradually increasing the converter duty cycle at a fourth determined rate.

Another embodiment may include a controller configured for operating at least one converter switch of a power system converter at a first converter duty cycle and operating at least one inverter switch of a power system inverter at a first inverter duty cycle. At least one of the power system or an electrical distribution network can be monitored for a shutdown condition, the monitoring of the power system including monitoring at least one of the converter, a power source having at least one energy storage device coupled to the converter, or the inverter. A response to a shutdown condition can include gradually reducing a converter duty cycle of the at least one converter switch from the first converter duty cycle to a second converter duty cycle, gradually reducing an inverter duty cycle of the at least one inverter switch from the first inverter duty cycle to a second inverter duty cycle, and/or electrically decoupling the power source from the converter.

Other aspects of the invention provide methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWING

These and other features of the disclosure will be more readily understood from the following detailed description of the various aspects of the invention taken in conjunction with the accompanying drawings that depict various aspects of the invention.

FIG. 1 shows a schematic diagram of an example of a power system that may include embodiments of the invention disclosed herein may be applied.

FIG. 2 shows a schematic flow diagram of an example of a shutdown method for the power system shown in FIG. 1, according to embodiments of the invention disclosed herein.

FIG. 3 shows a schematic flow diagram of an example of a startup method for the power system shown in FIG. 1, according to embodiments of the invention disclosed herein.

FIG. 4 shows a schematic block diagram of a computing environment for implementing power system operation and/or control according to embodiments of the invention disclosed herein.

It is noted that the drawings may not be to scale. The drawings are intended to depict only typical aspects of the invention, and therefore should not be considered as limiting the scope of the invention. In the drawings, like numbering represents like elements between the drawings. The detailed description explains embodiments of the invention, together with advantages and features, by way of example with reference to the drawings.

### DETAILED DESCRIPTION OF THE INVENTION

As used herein, the term “gradual” refers to a change from a first state to a second state over a period and including a plurality of intermediate states, rather than an instantaneous or substantially instantaneous change from the first state to the second state. In particular, a gradual change in a duty cycle is an adjustment from a first value of the duty cycle to a second value of the duty cycle that is accomplished over a period and that includes a plurality of intermediate values, rather than an instantaneous or substantially instantaneous adjustment from the first value to the second value. Also as used herein, “gradually” means “in a gradual manner,” using the meaning of gradual described above.

Also as used herein, “duty cycle” refers to an amount of a given period during which a device and/or component thereof is engaged, enabled, and/or on. A typical period used is one second, and a duty cycle value can be expressed as a portion of each second, such as a percentage and/or fraction of a second, during which the component is “on,” so that a duty cycle value of zero, for example, can mean the component is off for substantially an entirety of each period, and a duty cycle value of one can mean the component is on for substantially an entirety of each period. Other periods can be used as may be suitable and/or appropriate. Alternatively, duty cycle can refer to an amount of a given time period during which the device and/or component is off, so that a duty cycle of zero can mean the device and/or component is on for substantially an entirety of each period and a duty cycle of one can mean the device and/or component is off for substantially and entirety of each period.

In addition, as used herein, “start up” means to enable, to engage, to turn on, and/or to start supplying power to a device and/or a component thereof. A “startup sequence” is a series of steps or actions taken to start up a device or component thereof. A startup sequence can be performed in response to a startup event and/or a startup condition. A “startup event” can be a command, a signal, an instruction, a change in an environmental variable, and/or any other occurrence that might indicate that a startup sequence should be performed. Similarly, a “startup condition” can be an environmental state in which a startup sequence should be performed.

Further, as used herein, “shut down” means to disable, disengage, turn off, and/or stop supplying power to a device and/or a component thereof. A “shutdown sequence” is a series of steps or actions taken to shut down a device or component thereof. A shutdown sequence can be performed in response to a shutdown event or a shutdown condition. A “shutdown event” can be a command, a signal, an instruction, a change in an environmental variable, and/or any other occurrence that might indicate that a device and/or component thereof should be shut down, which can also indicate that a shutdown sequence should be performed. Similarly, a “shutdown condition” can be an environmental state in which a device and/or a component thereof should be shut down, and/or in which a shutdown sequence should be performed.

As described herein, a power system can include at least one power source and a power converter and at least one power source, which can include at least one energy storage unit, such as a battery or another energy storage device. The power converter can include a boost converter coupled to the battery, as well as an inverter coupled to the boost converter by a DC bus. The inverter can be coupled to an electrical distribution network for supplying electrical energy to the network and for drawing electrical energy from the network for storage in the battery. A converter controller can control the operation of the boost converter, and an inverter controller can control the operation of the inverter. The converter controller can adjust a duty cycle of at least one converter switch within the converter, and the inverter controller can adjust a duty cycle of at least one inverter switch within the inverter. If a shutdown event occurs and/or a shutdown condition exists, the duty cycle of the converter switches can be gradually reduced so that a voltage across the DC bus is gradually reduced. The duty cycle of the inverter switches can also be gradually reduced, either sequentially or simultaneously with the reduction of the converter switch duty cycle, so that an amount of power supplied to the electrical distribution network can be gradually reduced. If a startup event occurs and/or a startup condition exists, the duty cycle of the inverter switches can be gradually increased so that an amount of power supplied to the network is gradually increased. The duty cycle of the converter switches can also be gradually increased so that the voltage across the DC bus is gradually increased. Accordingly, the power converter and methods described herein enable the energy storage system to operate during shutdown and startup events without sustaining undesired voltage amplitudes across the DC bus and without producing rapid changes in the power supplied to the electrical distribution network.

As an example of gradual duty cycle adjustment in accordance with the meanings of “gradual” and “gradually” described above, a duty cycle can be gradually adjusted if the duty cycle changes from a first value to a second value during a period of 50 milliseconds (ms) or greater so that the duty cycle is set to a plurality of increasing or decreasing intermediate values between the first value and the second value. Alternatively, the duty cycle can be gradually adjusted by changing from the first value to the second value during a time period of about 100 ms or greater, or any other time period that enables the duty cycle to be adjusted such that the duty cycle is set to a plurality of increasing or decreasing intermediate values between the first value and the second value. Examples of duty cycle values can include from about zero to about one, where zero represents an off state in which the controlled component(s) is on zero percent of a unit of time, one represents an on state in which the controlled component is on for substantially all of a unit of time, and a number between zero and one represents a partially on (or off) state and/or a percentage of a unit of time in which the controlled component is on. Other expressions of duty cycle values as may be suitable and/or appropriate and/or as are known and/or may be developed can also be employed.

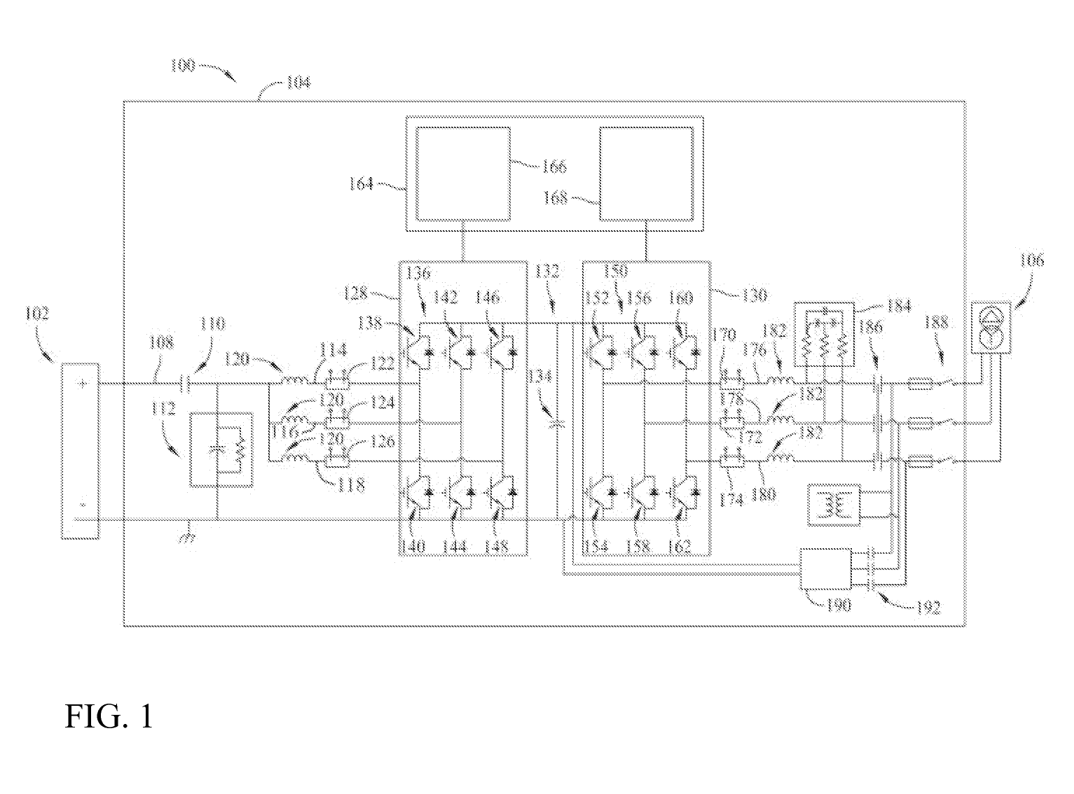

FIG. 1 is a schematic diagram of an exemplary power system 100 that can include at least one power source 102, such as a power generation unit and/or an energy storage device, and that can be electrically coupled to an electrical distribution network 106. Examples of power generation units that can be used in embodiments include, solar panels and/or arrays (not shown), wind turbines, fuel cells, geothermal generators, hydropower generators, and/or any other devices that generate and/or produce power from renewable and/or non-renewable energy sources in any suitable number. In addition, examples of energy storage devices that can be used in embodiments include batteries, capacitors, inductors, fuel cells, mechanical energy storage devices, such as holding ponds associated with respective hydropower installations and/or spring motors and/or flywheels associated with respective generators, and/or any other suitable type of energy storage units or devices in any suitable number. Many types of batteries can be employed as energy storage devices in embodiments, including, but not limited to, sodium nickel halide, lithium air, lithium ion, lithium sulfur, thin film lithium, lithium ion polymer, nickel metal hydride, lithium titanate, alkaline, lithium iron phosphate, nickel cadmium, lead acid, nickel iron, nickel hydrogen, nickel zinc, sodium ion, zinc bromide, vanadium redox, sodium sulfur, silver oxide, molten salt, and/or any other suitable and/or desired type of battery now known and/or as may be developed and/or any combination thereof. Likewise, any suitable fuel cell can be used, including, but not limited to, direct methanol, polymer electrolyte membrane, alkaline, phosphoric acid, molten carbonate, solid oxide, and/or any other suitable and/or desired type of fuel cell now known and/or as may be developed and/or any combination thereof.

In the exemplary embodiment, power system 100 can include any number of power sources 102 to facilitate operating power system 100 at a desired power output. Power system 100 can include a plurality of power sources 102 coupled together in a series-parallel configuration to facilitate providing a desired current and/or voltage output from power system 100. In addition, such an arrangement of power sources 102 can facilitate storage of power from another of power sources 102, such as a power generation device, and/or electrical distribution network 106 in one or more energy storage device(s) of power source(s) 102. In addition, the at least one power source 102 can be coupled to a power converter or power converter system 104 that can convert DC power produced by the at least one power source 102 to AC power. The AC power can then be transmitted to electrical distribution network 106. Power converter 104 can, in embodiments, adjust an amplitude of the voltage and/or current of the converted AC power to an amplitude suitable for electrical distribution network or grid 106. In addition, power converter 104 can provide AC power at a frequency and/or a phase that substantially equal to a frequency and/or phase extant on electrical distribution network 106. In particular embodiments, power converter 104 can provide three phase AC power to electrical distribution network or grid 106.

DC power produced by power source(s) 102, in the exemplary embodiment, can be transmitted through a converter conductor 108 in electrical communication with power converter 104. A protection device 110 can electrically disconnect power source(s) 102 from power converter 104, for example, if an error or a fault occurs within power system 100. As used herein, the terms “disconnect” and “decouple” are used interchangeably, and the terms “connect” and “couple” are used interchangeably. Protection device 110 in embodiments can be a current protection device, such as a circuit breaker, a fuse, a contactor, and/or any other device that enables power source(s) 102 to be controllable disconnected from power converter 104. A DC filter 112 can be coupled to converter conductor for use in filtering an input voltage and/or current received from power source(s) 102.

Converter conductor 108, in the exemplary embodiment, can be coupled to a first input conductor 114, a second input conductor, and/or a third input conductor 118 such that the input current can be split between first, second, and/or third input conductors 114, 116, 118. Alternatively, the input current can be conducted to a single conductor, such as converter conductor 108, and/or to any other number of conductors that can enable power system 100 to function as described herein and/or as desired. At least one boost inductor 120 can be coupled to each of first input conductor 114, second input conductor 116, and/or third input conductor 118. Each boost inductor 120 can facilitate filtering input voltage and/or current received from power source(s) 102. In addition, at least a portion of energy received from power source(s) 102 can be temporarily stored within each boost inductor 120. A first input current sensor 122 can be coupled to first input conductor 114, a second input current sensor 124 can be coupled to second input conductor 116, and/or a third input current sensor 126 can be coupled to third input conductor 118 so as to measure current flowing through a respective input conductor 114, 116, 118.

In the exemplary embodiment, power converter 104 can include a DC to DC or boost converter 128 and an inverter 130 coupled together by a DC bus 132. Boost converter 128 can be coupled to and receive DC power from power source(s) 102 through first, second, and/or third input conductors 114, 116, 118. In addition, boost converter 128 can adjust voltage and/or current amplitude of DC power received from power source(s) 102. In the exemplary embodiment, inverter 130 can be a DC-AC inverter that converts DC power received from boost converter 128 to AC power suitable for transmission to electrical distribution network 106. Moreover, in the exemplary embodiment, DC bus 132 can include at least one energy storage device 134, such as at least one capacitor and/or at least one of any other electrical energy storage device that can enable power converter 104 to function as described herein and/or as may be desired. As current is transmitted through power converter 104, a voltage can be generated across DC bus 132 and energy can be stored within energy storage device 134.

Boost converter 128, in the exemplary embodiment, can include two converter switches 136 coupled together in serial arrangement for each phase of electrical power that power converter 104 can produce. Converter switches 136 can be insulated gate bipolar transistors (IGBTs) in embodiments, though any other suitable transistor and/or switching device can be used. In addition, each pair of converter switches 136 for each respective phase can be coupled in parallel with any other pairs of converter switches 136 for any other respective phases. For example, where power converter 104 produces three phases, boost converter 128 can include a first converter switch 138 coupled in series with a second converter switch 140, a third converter switch 142 coupled in series with a fourth converter switch 144, and a fifth converter switch 146 coupled in series with a sixth converter switch 148. For such a three phase power converter 104, first and second converter switches 138, 140 are coupled in parallel with third and four converter switches 142, 144, and with fifth and sixth converter switches 146, 148. Alternatively, boost converter 128 can include any suitable number of converter switches 136 arranged in any suitable configuration.

Inverter 130, in the exemplary embodiment, can include two inverter switches 150 coupled together in serial arrangement for each phase of electrical power that can be produced by power converter 104. Each inverter switch 150 can be an IGBT and/or any other suitable transistor and/or any other suitable switching device in embodiments. In similar fashion to boost converter 138, each pair of inverter switches for each respective phase can be coupled in parallel with any other pairs of inverter switches 150 for any other respective phases. For example, where inverter 130 produces three phases, inverter 130 can include a first inverter switch 152 coupled in series with a second inverter switch 154, a third inverter switch 156 coupled in series with a fourth inverter switch 158, and a fifth inverter switch 160 coupled in series with a sixth inverter switch 162. For such a three phase power converter 104, first and second inverter switches 152, 154 can be coupled in parallel with third and four inverter switches 156, 158, and with fifth and sixth inverter switches 160, 0162. Alternatively, inverter 130 can include any suitable number of inverter switches 150 arranged in any suitable configuration.

Power converter 104 can include a control system 164 that can include a converter controller 166 and/or and inverter controller 168. Converter controller 166 can be coupled to and control operation of boost converter 128. In embodiments, converter controller 166 can operate boost converter 128 so as to maximize power received from power source(s) 102. Likewise, inverter controller 168 can be coupled to and control inverter 130. In embodiments, inverter controller 168 can operate inverter 130 so as to regulate voltage across DC bus 132 and/or to adjust voltage, current, phase, frequency, and/or any other characteristic of power output from inverter 130 to substantially match a corresponding characteristic extant in electrical distribution network 106.

Control system 164, converter controller 166, and/or inverter controller 168 in embodiments can include and/or can be implemented by at least one computing device and/or at least one processor. As used herein, each computing device and/or processor can include and suitable programmable circuit such as, for example, one or more systems and microcontrollers, microprocessors, reduced instruction set circuits (RISCs), complex instruction set circuits (CISCs), application specific integrated circuits (ASICs), programmable logic circuits (PLCs), field programmable gate arrays (FPGAs), and/or any other circuit capable of executing the functions described herein and/or as desired. The above examples are not intended to limit in any way the definition and/or meaning of the terms “processor” and/or “computing device.” In addition, control system 164, converter controller 166, and/or inverter controller 168 can include at least one memory device (not shown) that can store computer-executable instructions and/or data, such as operating data, parameters, setpoints, threshold values, and/or any other data that can enable control system 164 to function as described herein and/or as desired.

Converter controller 166 in embodiments can receive current measurement(s) from first input current sensor 122, second input current sensor 124, and/or third input current sensor 126. In addition, converter controller 166 can received measurement(s) of voltage of first input conductor 114, second input conductor 116, and/or third input conductor 118 from one or more respective voltage sensors (not shown). Likewise, inverter controller 168 in embodiments can receive current measurement(s) from a first output current sensor 170, a second output current sensor 172, and/or a third output current sensor 174. Further, inverter controller 168 can receive measurement(s) of a voltage output from inverter 130 from at least one output voltage sensor (not shown). In embodiments, converter controller 166 and/or inverter controller 168 can additionally receive voltage measurement(s) of the voltage across DC bus 132 from at least one DC bus voltage sensor (not shown).

In the exemplary embodiment, inverter 130 can be coupled to electrical distribution network or grid 106 by a first output conductor 176, a second output conductor 178, and/or a third output conductor 180. Inverter 130 can thus provide a first phase of AC power to electrical distribution network or grid 106 through first output conductor 176, a second phase of AC power to electrical distribution network or grid 106 through second output conductor 178, and/or a third phase of AC power to electrical distribution network or grid 106 through third output conductor 180. First output current sensor 170 can be coupled to first output conductor 176 so as to measure current flowing therethrough. Similarly, second output current sensor 172 can be coupled to second output conductor 178 so as to measure current flowing therethrough, and/or third output current sensor 174 can be coupled to third output conductor 180 so as to measure current flowing therethrough. At least one inductor 182 can be coupled to each of first output conductor 176, second output conductor 178, and/or third output conductor 180. Each inductor 182 can facilitate filtering output voltage and/or current received from 130. In addition, an AC filter 184 can be coupled to first output conductor 176, second output conductor 178, and/or third output conductor 180 to enable filtering an output voltage and/or current received from first, second, and third output conductors 176, 178, 180.

In the exemplary embodiment, at least one contactor 186 and/or at least one disconnect switch 188 are coupled to first output conductor 176, second output conductor 178, and/or third output conductor 180. Contactors 186 and disconnect switches 188 electrically disconnect inverter 130 from electrical distribution network 106, for example, if an error or a fault occurs within power system 100. Moreover, in the exemplary embodiment, protection device 110, contactors 186 and disconnect switches 188 are controlled by control system 164. Alternatively, protection device 110, contactors 186 and/or disconnect switches 188 are controlled by any other system that enables power converter 104 to function as described herein.

Power converter 104 also includes a bus charger 190 that is coupled to first output conductor 176, second output conductor 178, third output conductor 180, and to DC bus 132. In the exemplary embodiment, at least one charger contactor 192 is coupled to bus charger 190 for use in electrically disconnecting bus charger 190 from first output conductor 176, second output conductor 178, and/or third output conductor 180. Moreover, in the exemplary embodiment, bus charger 190 and/or charger contactors 192 are controlled by control system 164 for use in charging DC bus 132 to a determined voltage.

During operation, in the exemplary embodiment, power source(s) and/or another system 102, such as an energy storage device, generates or otherwise provides DC power and transmits the DC power to boost converter 128. Converter controller 166 controls a switching of converter switches 136 to adjust an output of boost converter 128. More specifically, in the exemplary embodiment, converter controller 166 controls the switching of converter switches 136 to adjust the voltage and/or current received from power source(s) 102 such that the power received from power source(s) 102 is increased and/or maximized.

Inverter controller 168, in the exemplary embodiment, controls a switching of inverter switches 150 to adjust an output of inverter 130. More specifically, in the exemplary embodiment, inverter controller 168 uses a suitable control algorithm, such as pulse width modulation (PWM) and/or any other control algorithm, to transform the DC power received from boost converter 128 into three phase AC power signals. Alternatively, inverter controller 168 causes inverter 130 to transform the DC power into a single phase AC power signal or any other signal that enables power converter 104 to function as described herein.

In the exemplary embodiment, each phase of the AC power is filtered by AC filter 184, and the filtered three phase AC power is transmitted to electrical distribution network 106. In the exemplary embodiment, three phase AC power is also transmitted from electrical distribution network 106 to DC bus 132 by bus charger 190. In one embodiment, bus charger 190 uses the AC power to charge DC bus 132 to a suitable voltage amplitude, for example, during a startup and/or a shutdown sequence of power converter 104.

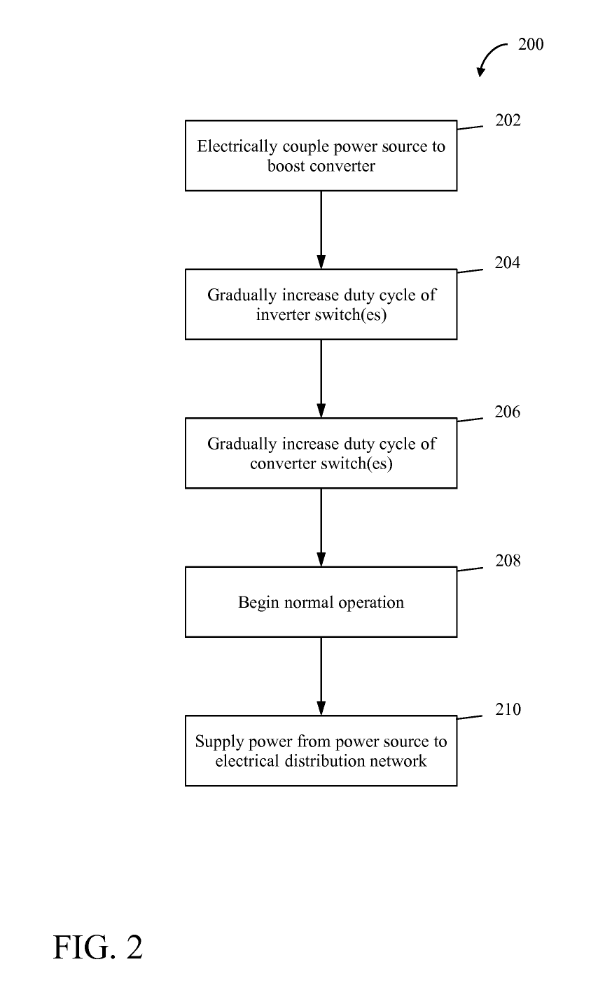

FIG. 2 is a flow diagram of an exemplary method 200 of operating power converter 104 (shown in FIG. 1) during a startup sequence of converter 104. In the exemplary embodiment, method 200 is implemented by control system 164, such as by converter controller 166 and/or inverter controller 168 (all shown in FIG. 1), in response to an occurrence of a startup event and/or a power surge event. Alternatively, method 200 can be implemented by any other system that enables power converter 104 to function as described herein.

A startup event can include an event in which a command signal is received from control system 164 and/or another system or device to start up power converter 104 in preparation for electrically coupling power source(s) 102 to electrical distribution network 106 to supply power to network 106. As used herein, the term “power surge event” refers to an event in which the output of power source(s) 102 is detected or determined to be above a predefined power output threshold. For example, where a solar power generator is used as a power source 102, in high sunlight conditions, such as during a sunny day, the irradiance of the solar power generator may be above the predefined irradiance threshold. The irradiance can be determined by one or more sensors (not shown) within or coupled to power source(s) 102, and/or can be determined based on the current detected by first input current sensor 122, second input current sensor 124, and/or third input current sensor 126 (shown in FIG. 1).

In the exemplary embodiment, before method 200 (i.e., the startup sequence) is executed, the duty cycles of converter switches 136 and inverter switches 150 are equal to about zero and protection device 110 is open such that power source(s) 102 is electrically decoupled from boost converter 128. Accordingly, no current and/or power is delivered from power source(s) 102 to electrical distribution network 106.

When method 200 is executed, protection device 110 is closed to electrically couple 202 power source(s) 102 to boost converter 128. The duty cycle of inverter switches 150 is gradually increased 204 by inverter controller 168. In the exemplary embodiment, the duty cycle of inverter switches 150 is increased 204 linearly from a first inverter duty cycle of about zero to an operating, or second inverter duty cycle. Alternatively, the duty cycle of inverter switches 150 is increased 204 using any other suitable rate or function that enables power converter 104 to function as described herein.

In the exemplary embodiment, the rate of the inverter duty cycle increase is at least partially based on characteristics or operating parameters of electrical distribution network 106. In one embodiment, the duty cycle of inverter switches 150 is increased 204 from about zero to the operating inverter duty cycle over a period of about one second. Alternatively, the duty cycle can be increased 204 to the operating inverter duty cycle over any other suitable period of time.

In an alternative embodiment, the duty cycle of inverter switches 150 is gradually increased 204 while the duty cycle of converter switches 136 is being increased 206 (as described herein). For example, the duty cycle of inverter switches 150 can be increased 204 after the duty cycle of converter switches 136 is above a determined threshold, or after a determined time period has elapsed from the time that converter controller 166 commences increasing 206 the duty cycle of converter switches 136.

After the duty cycle of inverter switches 150 has been increased 204 to the operating inverter duty cycle (or while the duty cycle of inverter switches 150 is being increased 204), the duty cycle of converter switches 136 is gradually increased 206 by converter controller 166. More specifically, in the exemplary embodiment, the duty cycle of converter switches 136 is increased 206 linearly from a first converter duty cycle of about zero to an operating, or second converter duty cycle. Alternatively, the duty cycle of converter switches 136 is increased 206 using any other suitable rate or function that enables power converter 104 to function as described herein.

In the exemplary embodiment, the rate of the converter duty cycle increase is at least partially based on an inductance of boost inductors 120 and/or a current flowing through inductors 120. In one embodiment, the duty cycle of converter switches 136 is increased 206 from about zero to the operating converter duty cycle over a period of about one second. Alternatively, the duty cycle can be increased to the operating converter duty cycle over any other suitable period of time. The converter duty cycle increase rate need not be the same as the inverter duty cycle increase rate and can be based on a different type of function. For example, the converter duty cycle increase rate could be linear while the inverter duty cycle increase rate is nonlinear or vice versa.

As converter controller 166 gradually increases 206 the duty cycle of converter switches 136, the voltage across DC bus 132 (shown in FIG. 1) is gradually increased as a result of an increased amount of current flowing through converter switches 136 from power source(s) 102. After the duty cycle of inverter switches 150 has reached the operating inverter duty cycle and the duty cycle of converter switches 136 has reached the operating converter duty cycle, power converter 104 begins 208 normal operation to maximize a power output of power source(s) 102. Power converter 104 then supplies 210 power from power source(s) 102 to electrical distribution network 106. Power converter 104 is maintained in the normal operating state until a shutdown sequence is executed and/or another suitable sequence is executed.

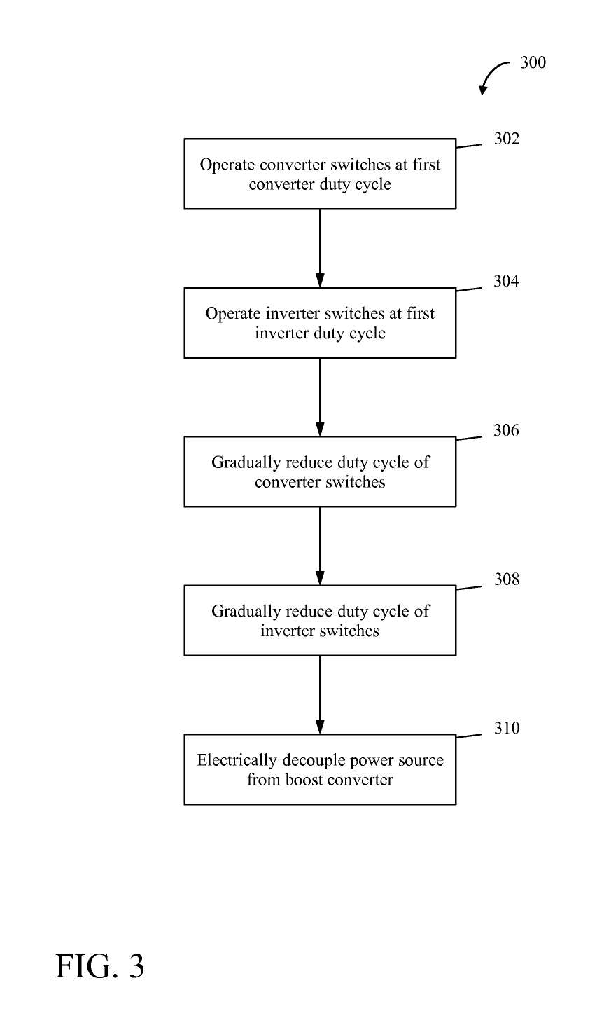

FIG. 3 is a flow diagram of an exemplary method of operating power converter 104 (shown in FIG. 1) during a shutdown sequence of converter 104. In the exemplary embodiment, method 300 is implemented by control system 164, such as by converter controller 166 and/or inverter controller 168 (all shown in FIG. 1), in response to an occurrence of a shutdown event and/or a low power output event. Alternatively, method 300 can be implemented by any other system that enables power converter 104 to function as described herein.

A shutdown event can include an event in which a command signal is received from control system 164 and/or another system or device to disable or shut down power converter 104 in preparation for electrically decoupling power source(s) 102 (shown in FIG. 1) from electrical distribution network 106. As used herein, the term “low power output event” refers to an event in which the power output of power source(s) 102 is detected to be below the predefined power output threshold. For example, where a solar power generator is used as a power source 102, in low sunlight conditions, such as during a cloudy day or at night, the irradiance of the solar generator may be reduced so that power output falls below the predefined power output threshold. The power output can be determined by one or more sensors (not shown) within or coupled to power source(s) 102, and/or can be determined based on the current detected by first input current sensor 122, second input current sensor 124, and/or third input current sensor 126 (shown in FIG. 1).

In the exemplary embodiment, during normal operation, converter switches 136 (shown in FIG. 1) can be operated 302, or switched, at a first converter duty cycle. More specifically, converter switches 136 can be controlled by converter controller 166 to switch at the first converter duty cycle or a first range of converter duty cycles, for example, to maximize a power output of power source(s) 102. In addition, inverter switches 150 (shown in FIG. 1) can be operated 304, or switched, at a first inverter duty cycle. More specifically, inverter switches 150 can be controlled by inverter controller 168 to switch at the first inverter duty cycle or a first range of inverter duty cycles, for example, to transmit energy from DC bus 132 (shown in FIG. 1) to electrical distribution network 106.

Converter controller 166 can gradually reduce 306 the duty cycle of converter switches 136. The voltage across DC bus 132 (shown in FIG. 1) gradually reduces as a result of a reduced amount of current flowing through converter switches 136. Energy stored within boost inductors 120 (shown in FIG. 1) can thus be controllably released or transmitted to DC bus 132 and to electrical distribution network 106 (shown in FIG. 1) by boost converter 128 and inverter 130.

In the exemplary embodiment, the duty cycle of converter switches 136 can be reduced 306 linearly from the operating or first converter duty cycle to a shutdown or second converter duty cycle of about zero. Alternatively, the duty cycle of converter switches 136 can be reduced 306 using any other suitable rate or function that enables power converter 104 to function as described herein and/or as may be desired. In the exemplary embodiment, the rate of the converter duty cycle reduction can be at least partially based on an inductance of boost inductors 120 and/or a current flowing through inductors 120. In one embodiment, the duty cycle of converter switches 136 can be reduced 306 from the operating duty cycle to about zero over a period of about one second. Alternatively, the duty cycle can be reduced to about zero over any other suitable period of time.

After the duty cycle of converter switches 136 has been reduced 306 to about zero (and the current flowing through converter switches 136 has been reduced to about zero), the duty cycle of inverter switches 150 can be gradually reduced 308 by inverter controller 168. In the exemplary embodiment, the duty cycle of inverter switches 150 can be reduced 308 linearly from the operating, or first inverter duty cycle to a shutdown, or second inverter duty cycle of about zero. Alternatively, the duty cycle of inverter switches 150 can be reduced 308 using any other suitable rate or function that enables power converter 104 to function as described herein and/or as may be desired.

In the exemplary embodiment, the rate of the inverter duty cycle reduction can be at least partially based on characteristics or operating parameters of electrical distribution network 106. In one embodiment, the duty cycle of inverter switches 150 can be reduced 308 from the operating duty cycle to about zero over a period of about one second. Alternatively, the duty cycle can be reduced to about zero over any other suitable period of time.

In an alternative embodiment, the duty cycle of inverter switches 150 can be gradually reduced 308 while the duty cycle of converter switches 136 is being reduced 306. For example, the duty cycle of inverter switches 150 can be reduced 308 after the duty cycle of converter switches 136 is below a determined threshold, or after a determined time period has elapsed from the time that converter controller 166 commences reducing 306 the duty cycle of converter switches 136. The inverter duty cycle decrease rate need not be the same as the converter duty cycle decrease rate and can be based on a different type of function. For example, the converter duty cycle increase rate could be linear while the inverter duty cycle increase rate is nonlinear or vice versa.

After the duty cycles of converter switches 136 and inverter switches 150 have been reduced to about zero, protection device 110 can be opened, thus electrically decoupling 310 power source(s) 102 from boost converter 128. Accordingly, current ceases flowing from power source(s) 102 through boost converter 128 to inverter 130 and power converter 104 is in a shutdown state. Power converter 104 is maintained in the shutdown state until a startup sequence is executed and/or another suitable sequence is executed.

As described herein with respect to FIGS. 2 and 3, control system 164 can gradually adjust the voltage across DC bus 132 during a shutdown sequence and/or a startup sequence of power converter 104. For example, during a startup sequence, control system 164 can gradually increase the duty cycles of converter switches 136 and inverter switches 150 to gradually increase the voltage across DC bus 132 and gradually increase the power supplied to electrical distribution network 106. During a shutdown sequence, control system 164 can gradually reduce the duty cycles of converter switches 136 and inverter switches 150 to gradually reduce the voltage across DC bus 132 and gradually reduce the power supplied to electrical distribution network 106.

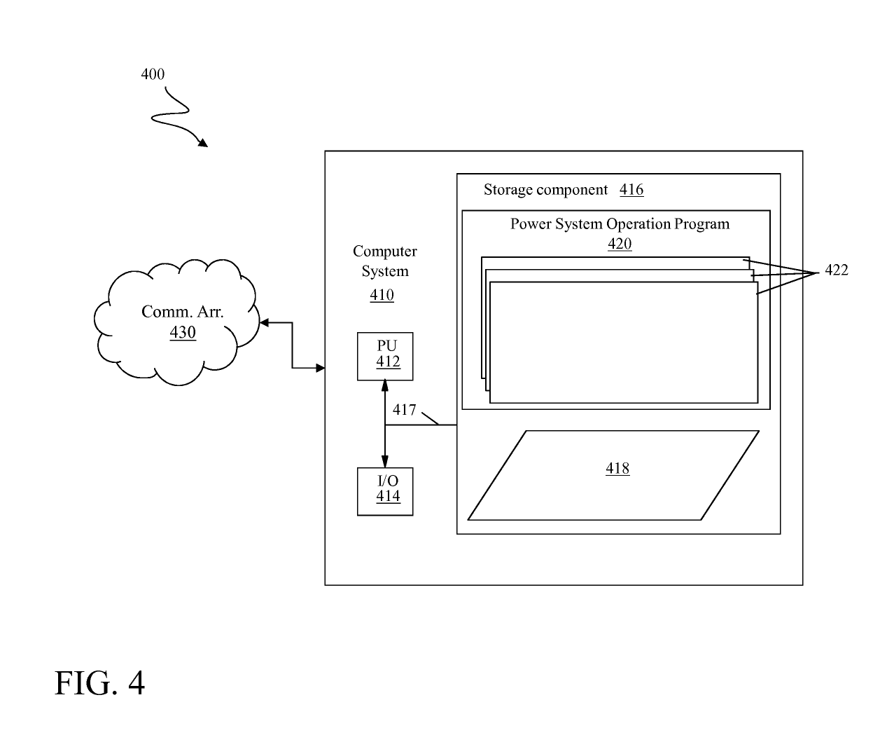

Turning to FIG. 4, an illustrative environment 400 for a power system operation computer program product is schematically illustrated according to an embodiment of the invention. To this extent, environment 400 includes a computer system 410, such as control system 164, converter controller 166, and/or inverter controller 168, and/or other computing device that can be part of a power system that can perform a process described herein in order to execute a power system operation method according to embodiments. In particular, computer system 410 is shown including a power system operation program 420, which makes computer system 410 operable to manage data in a power system operation control system or controller by performing a process described herein, such as an embodiment of the power system operation method 200, 300 discussed above.

Computer system 410 is shown including a processing component or unit (PU) 412 (e.g., one or more processors), an input/output (I/O) component 414 (e.g., one or more I/O interfaces and/or devices), a storage component 416 (e.g., a storage hierarchy), and a communications pathway 417. In general, processing component 412 executes program code, such as power system operation program 420, which is at least partially fixed in storage component 416, which can include one or more non-transitory computer readable storage medium or device. While executing program code, processing component 412 can process data, which can result in reading and/or writing transformed data from/to storage component 416 and/or I/O component 414 for further processing. Pathway 417 provides a communications link between each of the components in computer system 410. I/O component 414 can comprise one or more human I/O devices, which enable a human user to interact with computer system 410 and/or one or more communications devices to enable a system user to communicate with computer system 410 using any type of communications link. In addition, I/O component 414 can include one or more sensors, such as voltage, frequency, and/or current sensors as discussed above. In embodiments, a communications arrangement 430, such as networking hardware/software, enables computing device 410 to communicate with other devices in and outside of a power system and/or power system component in which it is installed. To this extent, power system operation program 420 can manage a set of interfaces (e.g., graphical user interface(s), application program interface, and/or the like) that enable human and/or system users to interact with power system operation program 420. Further, power system operation program 420 can manage (e.g., store, retrieve, create, manipulate, organize, present, etc.) data, such as power system operation data 418, using any solution. In embodiments, data can be received from one or more sensors, such as voltage, frequency, and/or current sensors as discussed above.

Computer system 410 can comprise one or more general purpose computing articles of manufacture (e.g., computing devices) capable of executing program code, such as power system operation program 420, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. Additionally, computer code can include object code, source code, and/or executable code, and can form part of a computer program product when on at least one computer readable medium. It is understood that the term “computer readable medium” can comprise one or more of any type of tangible, non-transitory medium of expression, now known or later developed, from which a copy of the program code can be perceived, reproduced, and/or otherwise communicated by a computing device. For example, the computer readable medium can comprise: one or more portable storage articles of manufacture, including storage devices; one or more memory/storage components of a computing device; paper; and/or the like. Examples of memory/storage components and/or storage devices include magnetic media (floppy diskettes, hard disc drives, tape, etc.), optical media (compact discs, digital versatile/video discs, magneto-optical discs, etc.), random access memory (RAM), read only memory (ROM), flash ROM, erasable programmable read only memory (EPROM), or any other tangible, non-transitory computer readable storage medium now known and/or later developed and/or discovered on which the computer program code is stored and with which the computer program code can be loaded into and executed by a computer. When the computer executes the computer program code, it becomes an apparatus for practicing the invention, and on a general purpose microprocessor, specific logic circuits are created by configuration of the microprocessor with computer code segments.

A technical effect of the systems and methods described herein can include electrically coupling a power source to a converter including at least one converter switch, wherein the converter can be coupled to an inverter including at least one inverter switch, gradually increasing a duty cycle of at least one inverter switch, gradually increasing a duty cycle of at least one converter switch, and/or supplying power from a power source to an electrical distribution network. An additional technical effect of the systems and methods described herein can include operating at least one converter switch at a first converter duty cycle, wherein the at least one converter switch is included within a converter, and wherein the converter can be coupled to a power source, operating at least one inverter switch at a first inverter duty cycle, wherein the at least one inverter switch can be included within an inverter, gradually reducing a duty cycle of at least one converter switch, gradually reducing a duty cycle of at least one inverter switch, and/or electrically decoupling a power source from a converter.

The computer program code can be written in computer instructions executable by the controller or computing device, such as in the form of software encoded in any programming language. Examples of suitable computer instruction and/or programming languages include, but are not limited to, assembly language, Verilog, Verilog HDL (Verilog Hardware Description Language), Very High Speed IC Hardware Description Language (VHSIC HDL or VHDL), FORTRAN (Formula Translation), C, C++, C#, Java, ALGOL (Algorithmic Language), BASIC (Beginner All-Purpose Symbolic Instruction Code), APL (A Programming Language), ActiveX, Python, Perl, php, Tcl (Tool Command Language), HTML (HyperText Markup Language), XML (eXtensible Markup Language), and any combination or derivative of one or more of these and/or others now known and/or later developed and/or discovered. To this extent, power system operation program 420 can be embodied as any combination of system software and/or application software.

Further, power system operation program 420 can be implemented using a set of modules 422. In this case, a module 422 can enable computer system 410 to perform a set of tasks used by power system operation program 420, and can be separately developed and/or implemented apart from other portions of power system operation program 420. As used herein, the term “component” means any configuration of hardware, with or without software, which implements the functionality described in conjunction therewith using any solution, while the term “module” means program code that enables a computer system 410 to implement the actions described in conjunction therewith using any solution. When fixed in a storage component 416 of a computer system 410 that includes a processing component 412, a module is a substantial portion of a component that implements the actions. Regardless, it is understood that two or more components, modules, and/or systems can share some/all of their respective hardware and/or software. Further, it is understood that some of the functionality discussed herein may not be implemented or additional functionality may be included as part of computer system 410.

When computer system 410 comprises multiple computing devices, each computing device can have only a portion of power system operation program 420 fixed thereon (e.g., one or more modules 422). However, it is understood that computer system 410 and power system operation program 420 are only representative of various possible equivalent computer systems that can perform a process described herein. To this extent, in other embodiments, the functionality provided by computer system 410 and power system operation program 420 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 410 includes multiple computing devices, the computing devices can communicate over any type of communications link. Further, while performing a process described herein, computer system 410 can communicate with one or more other computer systems using any type of communications link. In either case, the communications link can comprise any combination of various types of wired and/or wireless links; comprise any combination of one or more types of networks; and/or utilize any combination of various types of transmission techniques and protocols now known and/or later developed and/or discovered.

As discussed herein, power system operation program 420 enables computer system 410 to implement a power system operation product and/or method, such as that shown schematically in FIGS. 2 and 3. Computer system 410 can obtain power system operation data 418 using any solution. For example, computer system 410 can generate and/or be used to generate power system operation data 418, retrieve power system operation data 418 from one or more data stores, and/or receive power system operation data 418 from another system or device, such as one or more sensors, in or outside of a power system and/or the like.

In another embodiment, the invention provides a method of providing a copy of program code, such as power system operation program 420 (FIG. 4), which implements some or all of a process described herein, such as that shown schematically in and described with reference to FIGS. 2 and 3. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one tangible, non-transitory computer readable medium. In either case, the set of data signals can be transmitted/received using any type of communications link.

In still another embodiment, the invention provides a method of generating a system for implementing a power system operation product and/or method. In this case, a computer system, such as computer system 410 (FIG. 4), can be obtained (e.g., created, maintained, made available, etc.), and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A power system comprising:
a power source including at least one energy storage device; and
a control system coupled to a converter and to an inverter, the converter being coupled to the power source and to a bus, the inverter being coupled to the bus, and the control system configured to gradually adjust a voltage across the bus during at least one of a shutdown sequence or a startup sequence of the power system.

2. The power system of claim 1, wherein the converter comprises at least one converter switch and the control system is configured to gradually adjust the voltage across the bus by adjusting a duty cycle of the at least one converter switch between a first converter duty cycle and a second converter duty cycle during at least one of the shutdown sequence or the startup sequence.

3. The power system of claim 2, wherein the control system gradually adjusts the converter duty cycle at a rate determined at least in part based on a characteristic of an inductor of the converter.

4. The power system of claim 2, wherein the control system adjusts the duty cycle of the at least one converter switch between the first converter duty cycle and the second converter duty cycle at a substantially linear rate.

5. The power system of claim 2, wherein the first converter duty cycle is greater than the second converter duty cycle, the second converter duty cycle is about zero, and the control system gradually reduces the duty cycle of the at least one converter switch from the first converter duty cycle to the second converter duty cycle during the shutdown sequence.

6. The power system of claim 2, wherein the first converter duty cycle is less than the second converter duty cycle, the first converter duty cycle is about zero, and the control system gradually increases the duty cycle of the at least one converter switch from the first converter duty cycle to the second converter duty cycle during the startup sequence.

7. The power system of claim 1, wherein the inverter comprises at least one inverter switch and the control system is further configured to adjust a duty cycle of the at least one inverter switch between a first inverter duty cycle and a second inverter duty cycle during at least one of the shutdown sequence or the startup sequence.

8. The power system of claim 7, wherein the inverter is configured to be coupled to an electrical distribution network and the control system gradually adjusts the duty cycle at a rate determined at least in part based on a characteristic of the electrical distribution network.

9. The power system of claim 7, wherein the control system gradually adjusts the duty cycle of the at least one inverter switch between the first inverter duty cycle and the second inverter duty cycle at a substantially linear rate.

10. The power system of claim 7, wherein the first inverter duty cycle is greater than the second inverter duty cycle, the second inverter duty cycle is about zero, and the control system gradually reduces the duty cycle of the at least one inverter switch from the first inverter duty cycle to the second inverter duty cycle during the shutdown sequence.

11. The power system of claim 6, wherein the first inverter duty cycle is less than the second inverter duty cycle, the first inverter duty cycle is about zero, and the control system gradually increases the duty cycle of the at least one inverter switch from the first inverter duty cycle to the second inverter duty cycle during the startup sequence.

12. A method comprising:
monitoring at least one of a power system or an electrical distribution network for at least one of a shutdown condition or a startup condition, the monitoring of the power system including monitoring at least one of a power source having at least one energy storage device, a converter coupled to the power source, or an inverter coupled to the converter;
responding to a shutdown condition occurring in at least one of the power system or the electrical distribution network by:
gradually reducing a converter duty cycle of at least one converter switch of the converter at a first determined rate; and
gradually reducing an inverter duty cycle of at least one inverter switch of the inverter at a second determined rate; or
responding to a startup condition occurring in at least one of the power system or the electrical distribution network by:
gradually increasing the inverter duty cycle at a third determined rate; and
gradually increasing the converter duty cycle at a fourth determined rate.

13. The method of claim 12, wherein at least one of the first determined rate or the second determined rate is linear.

14. The method of claim 12, wherein the duty cycle of the at least one inverter switch is gradually decreased after the duty cycle of the at least one converter switch is gradually decreased

15. The method of claim 12, wherein at least one of the third determined rate or the fourth determined rate is linear.

16. The method of claim 12, wherein the monitoring of the at least one of the power system or the electrical distribution network is performed before the electrically coupling of the power source to the converter, and the electrically coupling of the power source to the converter is performed responsive to determining that a startup condition has occurred in at least one of the power system or the electrical distribution network.

17. The method of claim 12, wherein the duty cycle of the at least one converter switch is gradually increased after the duty cycle of the at least one inverter switch is gradually increased.

18. A controller, configured for operating at least one converter switch of a power system converter at a first converter duty cycle;
operating at least one inverter switch of a power system inverter at a first inverter duty cycle;
monitoring at least one of the power system or an electrical distribution network for a shutdown condition, the monitoring of the power system including monitoring at least one of the converter, a power source having at least one energy storage device coupled to the converter, or the inverter; and
responding to a shutdown condition in at least one of the power system or the electrical distribution network by at least one of:
gradually reducing a converter duty cycle of the at least one converter switch from the first converter duty cycle to a second converter duty cycle;
gradually reducing an inverter duty cycle of the at least one inverter switch from the first inverter duty cycle to a second inverter duty cycle; or
electrically decoupling the power source from the converter.

19. The controller of claim 18, wherein the gradually reducing of at least one of the converter duty cycle or the inverter duty cycle is reduced linearly.

20. The computer program product of claim 18, wherein the gradually reducing of the inverter duty cycle begins after the gradually reducing of the converter cycle and after the converter duty cycle reaches a determined threshold value.
